(19) United States
(12) Patent Application Publication
(10) Pub. No.: US 2025/0389945 A1
(43) Pub. Date: Dec. 25, 2025

(54) EYEPIECE SYSTEM AND NEAR-EYE DISPLAY DEVICE

(71) Applicants: Beijing BOE Display Technology Co., Ltd., Beijing (CN); BOE Technology Group Co., Ltd., Beijing (CN)

(72) Inventors: Chenru WANG, Beijing (CN); Ruijun DONG, Beijing (CN); Hao ZHANG, Beijing (CN); Lili CHEN, Beijing (CN); Yulong WU, Beijing (CN); Jiarong BAI, Beijing (CN); Na HAN, Beijing (CN); Haitao HUANG, Beijing (CN); Aodi MIAO, Beijing (CN)

(73) Assignees: Beijing BOE Display Technology Co., Ltd., Beijing (CN); BOE Technology Group Co., Ltd., Beijing (CN)

(21) Appl. No.: 18/998,521

(22) PCT Filed: Jul. 26, 2023
(86) PCT No.: PCT/CN2023/109404

§ 371 Date: Jan. 27, 2025

(30) Foreign Application Priority Data
Jul. 28, 2022 (CN) 202210903874.2

(51) Int. Cl. G02B 25/00; G02B 9/64; G02B 27/01

(52) U.S. Cl. CPC G02B 25/001; G02B 9/64; G02B 27/0172

(57) ABSTRACT

An eyepiece system is applied to a near-eye display device and includes: a plurality of lenses sequentially disposed along an optical axis from an image-side to an object-side, wherein a refractive index of each of the plurality of lenses is greater than 1.65, and a total system length of the plurality of lenses along the optical axis is less than or equal to 25 mm.

### CROSS-REFERENCE TO RELATED APPLICATION

This disclosure claims priority to Chinese Patent Application No. 202210903874.2, filed on Jul. 28, 2022 and entitled “Eyepiece System and Near-Eye Display Device”, the entire content of which is incorporated herein by reference in its entirety.

### TECHNICAL FIELD

This disclosure relates to the field of near-eye display technology and, more particularly, to an eyepiece system and a near-eye display device.

### BACKGROUND

NED (Near-Eye Display) refers to that image light emitted by a miniature image light source is guided through an eyepiece system to a pupil of a user by optical technology, and a virtual and magnified image is realized in a near-eye range of the user, to provide the user with intuitive image, video or text information. At present, near-eye display technology on the market is widely used in VR (Virtual Reality) systems, AR (Augmented Reality) systems, MR (Mixed Reality) systems, and so on.

With the increasing demand of users for interactivity and immersion of information such as virtual images and text, related near-eye display devices such as head-mounted displays, AR glasses, and VR helmets are more popular.

It should be noted that information disclosed in the Background is only used to acquire a better understanding of the background of this disclosure and therefore may include information that does not constitute the related art already known to those skilled in the art.

### SUMMARY

An objective of this disclosure is to provide an eyepiece system and a near-eye display device, which can realize miniaturization of the eyepiece system and hence realize miniaturization of the near-eye display device.

According to an aspect of this disclosure, there is provided an eyepiece system applied to a near-eye display device, the eyepiece system including:
a plurality of lenses sequentially disposed along a same optical axis from an image-side to an object-side, wherein a refractive index of each of the plurality of lenses is greater than 1.65, and a total system length of the plurality of lenses along a main optical axis is less than or equal to 25 mm.

In the eyepiece system according to this disclosure, the plurality of lenses are disposed along a same linear direction.

In the eyepiece system according to this disclosure, a focal power of the eyepiece system is greater than or equal to 50 m⁻¹ and less than or equal to 65 m⁻¹.

In the eyepiece system according to this disclosure, the plurality of lenses sequentially disposed along the same optical axis from the image-side to the object-side include:
a first lens having a convex image-side surface and a concave or planar object-side surface;
a second lens having a convex image-side surface and a concave object-side surface;
a third lens having a convex image-side surface and a concave object-side surface;
a fourth lens having a convex image-side surface and a concave object-side surface;
a fifth lens having a convex image-side surface and a convex object-side surface, or having a convex image-side surface and a planar object-side surface;
a sixth lens having a concave image-side surface and a convex object-side surface; and
a seventh lens having a convex image-side surface and a concave object-side surface, or having a planar image-side surface and a convex object-side surface.

In the eyepiece system according to this disclosure, the first lens, the second lens, the third lens, the fifth lens, and the seventh lens are positive focal power lenses, and the fourth lens and the sixth lens are negative focal power lenses.

In the eyepiece system according to this disclosure, the image-side surface and the object-side surface of each of the plurality of lenses are spherical surfaces; or
the image-side surface and the object-side surface of the first lens, the object-side surface of
the second lens, the image-side surface and the object-side surface of the third lens, the image-side surface and the object-side surface of the fourth lens, the image-side surface and the object-side surface of the fifth lens, the image-side surface and the object-side surface of the sixth lens, and the object-side surface of the seventh lens are spherical surfaces; and the image-side surface of the second lens and the image-side surface of the seventh lens are aspheric surfaces; or
the image-side surface and the object-side surface of the first lens, the object-side surface of the second lens, the image-side surface and the object-side surface of the third lens, the image-side surface and the object-side surface of the fourth lens, the image-side surface and the object-side surface of the fifth lens, the object-side surface of the sixth lens, and the object-side surface of the seventh lens are spherical surfaces; and the image-side surface of the second lens, the image-side surface of the sixth lens, and the image-side surface of the seventh lens are aspheric surfaces.

In the eyepiece system according to this disclosure:
a center thickness of the first lens is greater than or equal to 2.6 mm and less than or equal to 3.4 mm;
a center thickness of the second lens is greater than or equal to 1.4 mm and less than or equal to 2.1 mm;
a center thickness of the third lens is greater than or equal to 2.4 mm and less than or equal to 3.5 mm;
a center thickness of the fourth lens is greater than or equal to 1.3 mm and less than or equal to 1.6 mm;
a center thickness of the fifth lens is greater than or equal to 1.7 mm and less than or equal to 2.4 mm;
a center thickness of the sixth lens is greater than or equal to 0.5 mm and less than or equal to 2.4 mm;
a center thickness of the seventh lens is greater than or equal to 1.8 mm and less than or equal to 3.8 mm.

In the eyepiece system according to this disclosure:
a radius of curvature of the image-side surface of the first lens is greater than or equal to 10 mm and less than or equal to 20 mm, and a radius of curvature of the object-side surface of the first lens is greater than or equal to 30 mm;
a radius of curvature of the image-side surface of the second lens is greater than or equal to 5 mm and less than or equal to 20 mm, and a radius of curvature of the object-side surface of the second lens is greater than or equal to 5 mm and less than or equal to 25 mm;
a radius of curvature of the image-side surface of the third lens is greater than or equal to 5 mm and less than or equal to 15 mm, and a radius of curvature of the object-side surface of the third lens is greater than or equal to 15 mm and less than or equal to 55 mm;
a radius of curvature of the image-side surface of the fourth lens is greater than or equal to 15 mm and less than or equal to 55 mm, and a radius of curvature of the object-side surface of the fourth lens is less than or equal to 10 mm;
a radius of curvature of the image-side surface of the fifth lens is greater than or equal to 5 mm and less than or equal to 110 mm, and a radius of curvature of the object-side surface of the fifth lens is greater than or equal to 10 mm;
a radius of curvature of the image-side surface of the sixth lens is less than or equal to 50 mm, and a radius of curvature of the object-side surface of the sixth lens is greater than or equal to mm and less than or equal to 40 mm;
a radius of curvature of the image-side surface of the seventh lens is greater than or equal to 5 mm, and a radius of curvature of the object-side surface of the seventh lens is greater than or equal 10 to 10 mm and less than or equal to 50 mm.

In the eyepiece system according to this disclosure, the object-side surface of the third lens and the image-side surface of the fourth lens are spherical surfaces, and have a same radius of curvature;
the object-side surface of the third lens and the image-side surface of the fourth lens are glued by an optical adhesive.

In the eyepiece system according to this disclosure:
a refractive index of the first lens is greater than or equal to 1.72 and less than or equal to 1.74;
a refractive index of the second lens is greater than or equal to 1.78 and less than or equal to 1.84;
a refractive index of the third lens is greater than or equal to 1.65 and less than or equal to 1.80;
a refractive index of the fourth lens is greater than or equal to 1.80 and less than or equal to 1.95;
a refractive index of the fifth lens is greater than or equal to 1.75 and less than or equal to 1.85;
a refractive index of the sixth lens and a refractive index of the seventh lens are each greater than or equal to 1.70 and less than or equal to 1.80.

In the eyepiece system according to this disclosure:
each of the first lens and the third lens has an Abbe number of greater than or equal to 45 and less than or equal to 60;
each of the second lens and the fifth lens has an Abbe number of greater than or equal to 40 and less than or equal to 50;
each of the fourth lens, the sixth lens, and the seventh has an Abbe number of greater than or equal to 20 and less than or equal to 30.

In the eyepiece system according to this disclosure, a material of each lens is glass or resin.

According to an aspect of this disclosure, there is provided with a near-eye display device, including:
an image source configured to output image light; and
the eyepiece system according to the above aspect, disposed in a light-emitting direction of the image source.

Embodiments of this disclosure at least include the following technical effects.

In the embodiments of this disclosure, the refractive index of each lens included in the eyepiece system is greater than 1.65, so that the total system length of the plurality of lenses is reduced on the premise that the eyepiece system has high refractive ability, so as to realize the miniaturization of the eyepiece system while ensuring high imaging quality of the eyepiece system.

It should be understood that the above general description and the following detailed description are only exemplary and explanatory, and do not limit this disclosure.

### BRIEF DESCRIPTION OF THE DRAWINGS

The accompanying drawings, which are incorporated into and constitute a part of this specification, illustrate embodiments consistent with this disclosure and, together with the description, serve to explain the principles of this disclosure. It is evident that the drawings in the following description are only some embodiments of this disclosure. For those skilled in the art, other drawings may be derived from these drawings without creative effort.

FIG. 1 is a structural schematic diagram of an eyepiece system according to an embodiment of this disclosure.

FIG. 2 is a schematic diagram of an optical path of an eyepiece system according to an embodiment of this disclosure.

FIG. 3 is a structural schematic diagram of another eyepiece system according to an embodiment of this disclosure.

FIG. 4 is a structural schematic diagram of yet another eyepiece system according to an embodiment of this disclosure.

FIG. 5 is a MTF curve diagram of an eyepiece system according to an embodiment of this disclosure.

FIG. 6 is a spot diagram of an eyepiece system according to an embodiment of this disclosure.

FIG. 7 is a MTF curve diagram of another eyepiece system according to an embodiment of this disclosure.

FIG. 8 is a spot diagram of another eyepiece system according to an embodiment of this disclosure.

FIG. 9 is a MTF curve diagram of yet another eyepiece system according to an embodiment of this disclosure.

FIG. 10 is a spot diagram of yet another eyepiece system according to an embodiment of this disclosure.

FIG. 11 is a MTF curve diagram of yet another eyepiece system according to an embodiment of this disclosure.

FIG. 12 is a spot diagram of yet another eyepiece system according to an embodiment of this disclosure.

FIG. 13 is a MTF curve diagram of still another eyepiece system according to an embodiment of this disclosure.

FIG. 14 is a spot diagram of still another eyepiece system according to an embodiment of this disclosure.

### REFERENCE NUMERALS

10. eyepiece system; 20. micro display screen; 30. pupil.

### DETAILED DESCRIPTION

Exemplary embodiments will be now described more fully with reference to the accompanying drawings. However, the exemplary embodiments can be embodied in a variety of forms and should not be construed as limiting the embodiments set forth herein. Instead, these embodiments are provided so that this disclosure will be thorough and complete, and the concepts of the exemplary embodiments will be fully given to those skilled in the art. Same reference numbers denote the same or similar structures in the figures, and thus the detailed description thereof will be omitted. In addition, the drawings are merely schematic illustrations of this disclosure, and are not necessarily drawn to scale.

Words such as “one.” “an/a.” “the,” “said” and “at least one” are used herein to indicate the presence of one or more elements/component parts/and others. Terms “including” and “having” have an inclusive meaning which means that there may be additional elements/component parts/and others in addition to the listed elements/component parts/and others. Terms “first,” “second” and “third” are used herein only as markers, and they do not limit the number of objects modified after them.

With the continuous development of near-eye display technology, for smart wearable devices, for example AR glasses, in order to meet use requirements of consumer-grade glasses, users need AR glasses with a smaller and smaller volume. Therefore, the smart wearable devices need to be miniaturized while ensuring image quality of near-eye display.

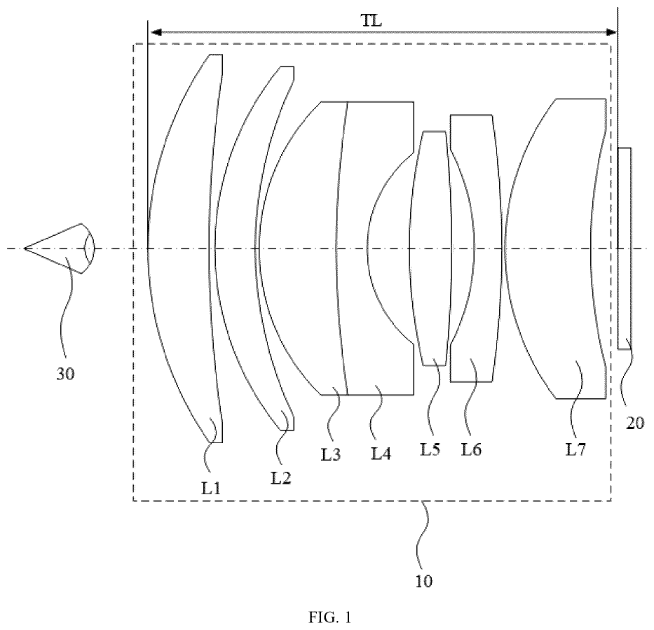

An embodiment of this disclosure provides a structural schematic diagram of an eyepiece system 10. As shown in FIG. 1, the eyepiece system 10 includes a plurality of lenses sequentially disposed along a same optical axis from an image-side to an object-side, refractive indexes of the plurality of lenses are all greater than 1.65, and a total system length TL of the plurality of lenses along a main optical axis is less than or equal to 25 mm.

In the embodiment of this disclosure, the refractive index of each lens included in the eyepiece system 10 is greater than 1.65, so that the total system length TL of the plurality of lenses L is reduced on the premise that the eyepiece system 10 has high focal power, and under the condition that the total system length of the plurality of lenses is reduced, the focal lengths of the eyepiece system 10 are synchronously reduced, so that the miniaturization of the eyepiece system 10 is realized while ensuring the eyepiece system 10 has high imaging quality.

The total system length TL of the plurality of lenses refers to a distance between an image-side of one of the plurality of lenses farthest from the micro display screen 20 and a center of the micro display screen 20 along the main optical axis. Optionally, the total system length of the plurality of lenses along the main optical axis may also be less than or equal to 21 mm, to further achieve miniaturization of the eyepiece system 10. Exemplarily, the total system length of the plurality of lenses along the main optical axis is 19 mm, 20 mm, 21 mm.

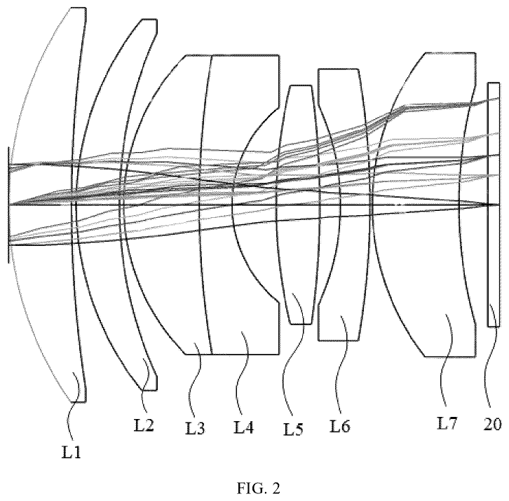

The eyepiece system 10 is usually used in combination with the micro-display screen 20, and the micro-display screen 20 and the eyepiece system 10 are distributed along the light path propagation direction. As shown in FIG. 2, the image light emitted by the micro display screen 20 is incident on the light incident side of the eyepiece system 10, and is refracted by the eyepiece system 10 to perform collimation amplification; and the refracted light is emitted from the light emergent side of the eyepiece system 10 and is incident into the pupil 30 of the user, so as to provide intuitive image, video or text information to the user in the near-eye range of the user.

The micro display screen 20 may be a micro display screen using a screen such as an LCD, an OLED, an LCOS, or an LED, and a screen size of the micro display screen 20 is 0.3 inches to 0.5 inches.

In the embodiment of this disclosure, the lens included in the eyepiece system 10 may be made of glass, resin, or plastic, and the plurality of lenses may be made of all the same material, all different material, or not exactly the same material.

The number of the lenses L included in the eyepiece system 10 may be five, six, seven, eight, etc., as long as the total system length TL of the plurality of lenses is less than or equal to 25 mm, which is not limited in the embodiments of this disclosure.

Optionally, the plurality of lenses are arranged along a same straight line direction. In this way, by arranging the plurality of lenses to be distributed along the same straight line direction, the condition that the size of the eyepiece system is large in the radial direction of the lenses is avoided.

Optionally, the plurality of lenses are sequentially disposed along a same optical axis, and in order to effectively reduce a total system length of the eyepiece system 10, a physical radius of the middle lens may be set to be minimum, a concave surface of a part of the image-side lens located on the image-side of the middle lens faces the object-side, and a physical radius of the image-side lens increases in a direction away from the object-side; and a concave surface of a part of the object-side lens located on the object-side of the middle lens faces the image-side, and a physical radius of the object-side lens increases in a direction away from the image-side. In this way, the image-side lens and the object-side lens on both sides of the middle lens may approach the middle lens to the greatest extent, to reduce the total system length of the eyepiece system 10.

When the total number of lenses included in the eyepiece system 10 is an odd number, the middle lens may be the most middle lens of the plurality of lenses, or may be a lens adjacent to the most middle lens. When the total number of lenses included in the eyepiece system 10 is an even number, the middle lens may be any one of two lenses located in the most middle of the plurality of lenses.

Optionally, the focal power of the eyepiece system 10 is greater than or equal to 50 m⁻¹, and less than or equal to 65 m⁻¹. In this way, the image light emitted by the micro display screen 20 may be diffused and refracted by using the eyepiece system 10, to ensure a large image light collimation effect, and at the same time, an exit pupil area that exits the pupil 30 is 5 mm*17 mm, and distortion is less than 3%. Therefore, the advantages of large exit pupil, small distortion and even no distortion of the virtual picture are achieved. Certainly, in addition to any value within the foregoing range, the focal power of the eyepiece system 10 may also be another value, provided that a large collimation effect of the eyepiece system 10 on image light can be ensured.

An example in which the eyepiece system 10 includes seven lenses will be explained below.

As shown in FIG. 1 or FIG. 2, the plurality of lenses include a first lens L1, a second lens L2, a third lens L3, a fourth lens L4, a fifth lens L5, a sixth lens L6 and a seventh lens L7.

Optionally, an image-side surface of the first lens L1 is a convex surface, and an object-side surface of the first lens L1 is a concave surface or a planar surface; an image-side surface of the second lens L2 is a convex surface, and an object-side surface of the second lens L2 is a concave surface; an image-side surface of the third lens L3 is a convex surface, and an object-side surface of the third lens L3 is a concave surface; an image-side surface of the fourth lens L4 is a convex surface, and an object-side surface of the fourth lens L4 is a concave surface; an image-side surface of the fifth lens L5 is a convex surface, an object-side surface of the fifth lens L5 is a convex surface, or an image-side surface of the fifth lens L5 is a convex surface, and an object-side surface of the fifth lens L5 is a planar surface; an image-side surface of the sixth lens L6 is a concave surface, and an object-side surface of the sixth lens L6 is a convex surface; an image-side surface of the seventh lens L7 is a convex surface, and an object-side surface of the seventh lens L7 is a concave surface; or an image-side surface of the seventh lens L7 is a planar surface, and an object-side surface of the seventh lens L7 is a convex surface. As shown in the figure, the shaping of the image light by the seven lenses is realized through the cooperation of the convex surface, the concave surface and the plane, so that the high-quality imaging quality is realized, that is, the image imaging quality of the eyepiece system 10 is improved.

The image-side surface mentioned above refers to a curved surface on a side of the lens close to the pupil 30 along the same optical axis, and the object-side surface refers to a curved surface on a side of the lens close to the micro display screen 20 along the same optical axis.

Example 1, as shown in FIG. 1 or FIG. 2, an image-side surface of the first lens L1 is a convex surface, and an object-side surface of the first lens L1 is a concave surface; an image-side surface of the second lens L2 is a convex surface, and an object-side surface of the second lens L2 is a concave surface; an image-side surface of the third lens L3 is a convex surface, and an object-side surface of the third lens L3 is a concave surface; an image-side surface of the fourth lens L4 is a convex surface, and an object-side surface of the fourth lens L4 is a concave surface; an image-side surface of the fifth lens L5 is a convex surface, and an object-side surface of the fifth lens L5 is a convex surface; an image-side surface of the sixth lens L6 is a concave surface, and an object-side surface of the sixth lens L6 is a convex surface; and an image-side surface of the seventh lens L7 is a convex surface, and an object-side surface of the seventh lens L7 is a concave surface.

Example 2, as shown in FIG. 3, an image-side surface of the first lens L1 is a convex surface, and an object-side surface of the first lens L1 is a plane; an image-side surface of the second lens L2 is a convex surface, and an object-side surface of the second lens L2 is a concave surface; an image-side surface of the third lens L3 is a convex surface, and an object-side surface of the third lens L3 is a concave surface; an image-side surface of the fourth lens L4 is a convex surface, and an object-side surface of the fourth lens L4 is a concave surface; an image-side surface of the fifth lens L5 is a convex surface, and an object-side surface of the fifth lens L5 is a convex surface; an image-side surface of the sixth lens L6 is a concave surface, and an object-side surface of the sixth lens L6 is a convex surface; and an image-side surface of the seventh lens L7 is a convex surface, and an object-side surface of the seventh lens L7 is a convex surface.

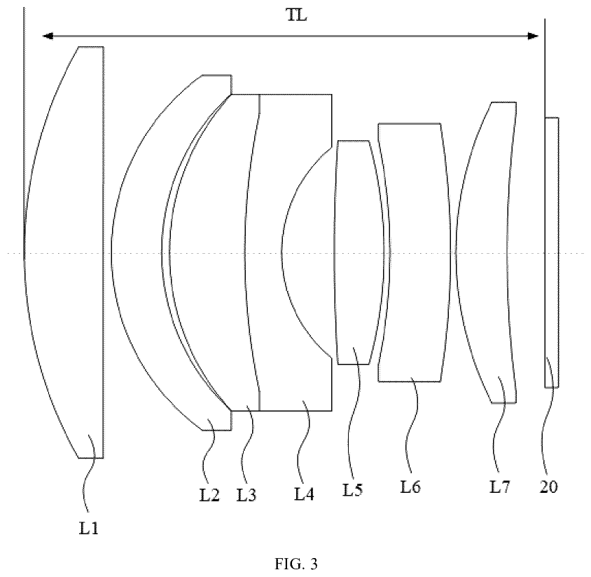

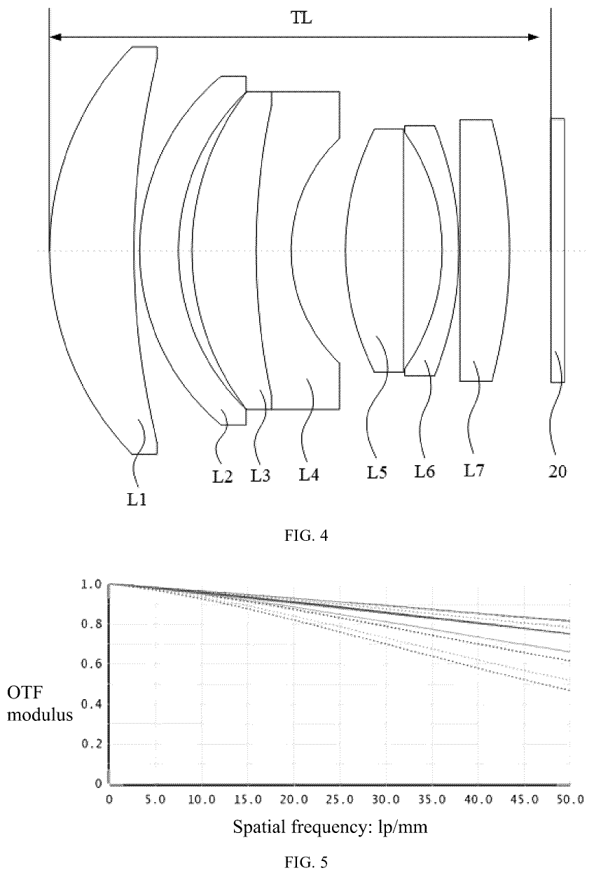

Example 3, as shown in FIG. 4, a side surface of the first lens L1 is a convex surface, and an object-side surface of the first lens L1 is a concave surface; an image-side surface of the second lens L2 is a convex surface, and an object-side surface of the second lens L2 is a concave surface; an image-side surface of the third lens L3 is a convex surface, and an object-side surface of the third lens L3 is a concave surface; an image-side surface of the fourth lens L4 is a convex surface, and an object-side surface of the fourth lens L4 is a concave surface; an image-side surface of the fifth lens L5 is a convex surface, and an object-side surface of the fifth lens L5 is a plane; an image-side surface of the sixth lens L6 is a concave surface, and an object-side surface of the sixth lens L6 is a convex surface; and an image-side surface of the seventh lens L7 is a plane, and an object-side surface of the seventh lens L7 is a convex surface.

Optionally; the image-side surface and the object-side surface of the first lens L1, the second lens L2, the third lens L3, the fourth lens L4, the fifth lens L5, the sixth lens L6, and the seventh lens L7 may be spherical or aspheric, and certainly, the image-side or object-side of some lenses can also be a plane.

In Example 1, the image-side surfaces and the object-side surfaces of the first lens L1, the second lens L2, the third lens L3, the fourth lens L4, the fifth lens L5, the sixth lens L6, and the seventh lens L7 are all spherical surfaces.

In Example 2, the image-side surface and the object-side surface of the first lens L1, the object-side surface of the second lens L2, the image-side surface and the object-side surface of the third lens L3, the image-side surface and the object-side surface of the fourth lens L4, the image-side surface and the object-side surface of the fifth lens L5, the image-side surface and the object-side surface of the sixth lens L6, and the object-side surface of the seventh lens L7 are all spherical surfaces, and the image-side surface of the second lens L2 and the image-side surface of the seventh lens are all aspheric surfaces.

In Example 3, the image-side surface and the object-side surface of the first lens L1, the object-side surface of the second lens L2, the image-side surface and the object-side surface of the third lens L3, the image-side surface and the object-side surface of the fourth lens L4, the image-side surface and the object-side surface of the fifth lens L5, the object-side surface of the sixth lens L6, and the object-side surface of the seventh lens L7 are all spherical surfaces, and the image-side surface of the second lens L2, the image-side surface of the sixth lens L6, and the image-side surface of the seventh lens L7 are all aspheric surfaces.

For a case where the curved surface is a spherical surface, the surface shape satisfies a first formula:

$$z = \frac{c {r}^{2}}{1 + {[ 1 - ( 1 + k ) {c}^{2} {r}^{2} ]}^{1 / 2}}$$

In the above first formula, z is the sagittal height of the spherical surface, c is the radius of curvature of the curved surface, k is the cone coefficient of the curved surface, and a constant 0 is taken for the spherical surface, and r is the physical radius of the lens corresponding to the curved surface.

For a case where the curved surface is aspheric, the surface shape satisfies a second formula:

$$z = \frac{c {r}^{2}}{1 + {[ 1 - ( 1 + k ) {c}^{2} {r}^{2} ]}^{1 / 2}} + {\sum }_{i} {A}_{2 i} {r}^{2 i}$$

In the above second formula, z is a sagittal height of the aspheric surface, c is a radius of curvature of the curved surface, k is a cone coefficient of the curved surface, r is a physical radius of a lens corresponding to the curved surface, A₂ᵢ is a 2*i-order coefficient of the aspheric surface, and i is an integer greater than or equal to 1.

Generally, for a multi-order coefficient of an aspheric surface, a fourth order coefficient of i=2 and a sixth order coefficient of i=3 are usually considered; certainly, a second order coefficient of i=1, an eighth order coefficient of i=4, and the like may also be considered, which may be specifically determined according to an actual situation.

Optionally, a center thickness of the first lens L1 is greater than or equal to 2.6 mm and less than or equal to 3.4 mm, a center thickness of the second lens L2 is greater than or equal to 1.4 mm and less than or equal to 2.1 mm, a center thickness of the third lens L3 is greater than or equal to 2.4 mm and less than or equal to 3.5 mm, a center thickness of the fourth lens L4 is greater than or equal to 1.3 mm and less than or equal to 1.6 mm, a center thickness of the fifth lens L5 is greater than or equal to 1.7 mm and less than or equal to 2.4 mm, a center thickness of the sixth lens L6 is greater than or equal to 0.5 mm and less than or equal to 2.4 mm, and a center thickness of the seventh lens L7 is greater than or equal to 1.8 mm and less than or equal to 3.8 mm. In this way, by limiting a center thickness of each lens, a total system length TL of the eyepiece system 10 formed by seven lenses is relatively small. The center thickness refers to the thickness of the lens in the direction of the main optical axis.

In addition, an intermediate distance between two adjacent lenses may be determined according to the surface shape of a curved surface of the two adjacent lenses. Specifically, if the surface shapes of opposite curved surfaces of two adjacent lenses are matched, a center spacing 20) between the two adjacent lenses may be 0); if surfaces of opposite curved surfaces of two adjacent lenses are not matched (curvature radii are different), to avoid interference between the two lenses, a center spacing between the two adjacent lenses needs to be determined by combining curvature radii of the two opposite curved surfaces. Further, for two adjacent lenses whose center spacing is not 0), in order to further ensure the collimation and amplification effect of the image light, the center spacing between the two adjacent lenses is greater than or equal to 0.1 mm.

Optionally, a radius of curvature of an image-side surface of the first lens L1 is greater than or equal to 10 mm and less than or equal to 20 mm, and a radius of curvature of an object-side surface of the first lens L1 is greater than or equal to 30 mm; a radius of curvature of an image-side surface of the second lens L2 is greater than or equal to 5 mm and less than or equal to 20 mm, and a radius of curvature of an object-side surface of the second lens L2 is greater than or equal to 5 mm and less than or equal to 25 mm; a radius of curvature of an image-side surface of the third lens L3 is greater than or equal to 5 mm and less than or equal to 15 mm, and a radius of curvature of an object-side surface of the third lens L3 is greater than or equal to 15 mm and less than or equal to 55 mm; a radius of curvature of an image-side surface of the fourth lens L4 is greater than or equal to 15 mm and less than or equal to 55 mm, and a radius of curvature of an object-side surface of the fourth lens L4 is less than or equal to 10 mm; a radius of curvature of an image-side surface of the fifth lens L5 is greater than or equal to 5 mm and less than or equal to 110 mm, and a radius of curvature of an object-side surface of the fifth lens L5 is greater than or equal to 10 mm; a radius of curvature of an image-side surface of the sixth lens L6 is less than or equal to 50 mm, and a radius of curvature of an object-side surface of the sixth lens L6 is greater than or equal to 10 mm and less than or equal to 40 mm; a radius of curvature of an image-side surface of the seventh lens L7 is greater than or equal to 5 mm, and a radius of curvature of an object-side surface of the seventh lens L7 is greater than or equal to mm and less than or equal to 50 mm.

For the curvature radii of the image-side surface and the object-side surface of each lens, if the surface shapes of the two opposite curved surfaces are spherical surfaces and the curvature radii are equal, the two corresponding lenses may be glued to reduce the number of individual members, thereby improving the assembly efficiency of the eyepiece system 10.

As an example, the object-side surface of the third lens L3 and the image-side surface of the fourth lens L4 are both spherical surfaces, and have the same radius of curvature; as shown in FIG. 1 or FIG. 2, the object-side surface of the third lens L3 and the image-side surface of the fourth lens L4 are glued to achieve gluing of the third lens L3 and the fourth lens L4.

The third lens L3 and the fourth lens L4 may be glued by an optical adhesive such as a photocurable adhesive or an epoxy resin adhesive. Certainly, the third lens L3 and the fourth lens L4 may also be glued by a light-transmitting adhesive, which is not limited in the embodiments of this disclosure.

Optionally, a refractive index of the first lens L1 is greater than or equal to 1.72 and less than or equal to 1.74; a refractive index of the second lens L2 is greater than or equal to 1.78 and less than or equal to 1.84; a refractive index of the third lens L3 is greater than or equal to 1.65 and less than or equal to 1.80; a refractive index of the fourth lens L4 is greater than or equal to 1.80 and less than or equal to 1.95; a refractive index of the fifth lens L5 is greater than or equal to 1.75 and less than or equal to 1.85; and a refractive index of the sixth lens L6 and a refractive index of the seventh lens L7 are both greater than or equal to 1.70 and less than or equal to 1.80. In this way, by limiting the refractive index of each lens, the refractive ability of the eyepiece system 10 is enhanced by matching the refractive indexes of the seven lenses, so as to reduce the total system length TL of the eyepiece system 10 and reduce the focal length of the eyepiece system 10.

Optionally, the Abbe number of the first lens L1 and the Abbe number of the third lens L3 are both greater than or equal to 45 and less than or equal to; the Abbe number of the second lens L2 and the Abbe number of the fifth lens L5 are both greater than or equal to 40 and less than or equal to; the Abbe numbers of the fourth lens L4, the sixth lens L6, and the seventh lens L7 are all greater than or equal to 20 and less than or equal to 30. In this way, by limiting the Abbe number of each lens of the eyepiece system 10, after the dispersion effect of each lens on the image light is matched, the dispersion of the image light is reduced, to improve the imaging quality of the eyepiece system 10.

Optionally; the first lens L1, the second lens L2, the third lens L3, the fifth lens L5, and the seventh lens L7 are all positive focal power lenses, and the fourth lens L4 and the sixth lens L6 are all negative focal power lenses.

The image light emitted by the micro display screen 20 may be collimated and amplified through diffusion refraction of the seventh lens L7, convergence refraction of the sixth lens L6, diffusion refraction of the fifth lens L5, convergence refraction of the fourth lens L4, and diffusion refraction of the third lens L3, the second lens L2, and the first lens L4, the exit pupil area to pupil 30 is 5 mm*17 mm, and the distortion is less than 3%, so as to achieving the advantages of large exit pupil, small distortion, or even no distortion in virtual images.

For example, in combination with the foregoing case in which the third lens L3 and the fourth lens L4 are glued, the focal power of the first lens L1 is greater than or equal to 32 m⁻¹ and less than or equal to 48 m⁻¹, the focal power of the second lens L2 is greater than or equal to 12 m⁻¹ and less than or equal to 26 m⁻¹, the focal power of the cemented lens (the third lens L3 and the fourth lens L4) is greater than or equal to −68 m⁻¹ and less than or equal to −45 m⁻¹, the focal power of the fifth lens L5 is greater than or equal to 52 m⁻¹ and less than or equal to 80 m⁻¹, the focal power of the sixth lens L6 is greater than or equal to −55 m⁻¹ and less than or equal to −25 m⁻¹, and the focal power of the seventh lens L7 is greater than or equal to 50 m⁻¹ and less than or equal to 65 m⁻¹.

Certainly, in the embodiments of this disclosure, for the sixth lens and the seventh lens, the sixth lens may also be a lens with positive focal power, and the seventh lens is a lens with negative focal power. For example, the sixth lens has a focal power greater than 0 and less than or equal to 8 m⁻¹, and the seventh lens has a focal power greater than or equal to −15 m⁻¹ and less than 0.

Embodiment 1: this disclosure shows various parameters of seven lenses included in the eyepiece system 10 in combination with Table 1 below.

TABLE 1
f = 15 mm TL = 20.48 mm FOV = 36°

| Lens | Surface | R/ | T/ | L/ | Φ/ | | |
|---|---|---|---|---|---|---|---|
| Name | Shape | mm | mm | mm | m⁻¹ | k | n, V |
| First | Image-Side | 14.706 | 2.69 | 0.2 | 36.62 | 0 | 1.73, 54.7 |
| Lens L1 | Surface | | | | | | |
| | Object Side | 51.911 | | | | 0 | |
| | Surface | | | | | | |
| Second | Image-Side | 12.632 | 1.84 | 0.19 | 21.32 | 0 | 1.82, 46.6 |
| Lens L2 | Surface | | | | | | |
| | Object Side | 17.619 | | | | 0 | |
| | Surface | | | | | | |
| Third | Image-Side | 9.032 | 3.23 | 0.00 | −47.44 | 0 | 1.68, 55.6 |
| Lens L3 | Surface | | | | | | |
| | Object Side | 38.294 | | | | 0 | |
| | Surface | | | | | | |
| Fourth | Image-Side | 38.294 | 1.4 | 1.88 | | 0 | 1.85, 23.8 |
| Lens L4 | Surface | | | | | | |
| | Object Side | 5.336 | | | | 0 | |
| | Surface | | | | | | |
| Fifth | Image-Side | 21.713 | 1.86 | 0.89 | 59.97 | 0 | 1.83, 42.7 |
| Lens L5 | Surface | | | | | | |
| | Object Side | −37.272 | | | | 0 | |
| | Surface | | | | | | |
| Sixth | Image-Side | −10.126 | 1.26 | 0.1 | −51.80 | 0 | 1.76, 26.6 |
| Lens L6 | Surface | | | | | | |
| | Object Side | −34.251 | | | | 0 | |
| | Surface | | | | | | |
| Seventh | Image-Side | 10.483 | 3.7 | 1.24 | 37.11 | 0 | 1.74, 27.8 |
| Lens L7 | Surface | | | | | | |
| | Object Side | 18.764 | | | | 0 | |
| | Surface | | | | | | |

In Table 1, f is a focal length, TL is a total system length, k is a cone coefficient, FOV is an angle of field of view, R is a radius of curvature, T is a center thickness, L is a center distance between itself and the object-side and the adjacent lens or micro display screen, Φ is an optical focal power (the third lens and the fourth lens are glued), n is a refractive index, and V is an Abbe number. In addition, the positive and negative of the radius of curvature of the image-side surface and the object-side surface refers to the relative position between the center of the curved surface and the corresponding surface. For example, a center of an image-side surface of the first lens L1 is located on an object-side of the image-side surface, and a center of an object-side surface of the fifth lens is located on an image-side of the object-side surface.

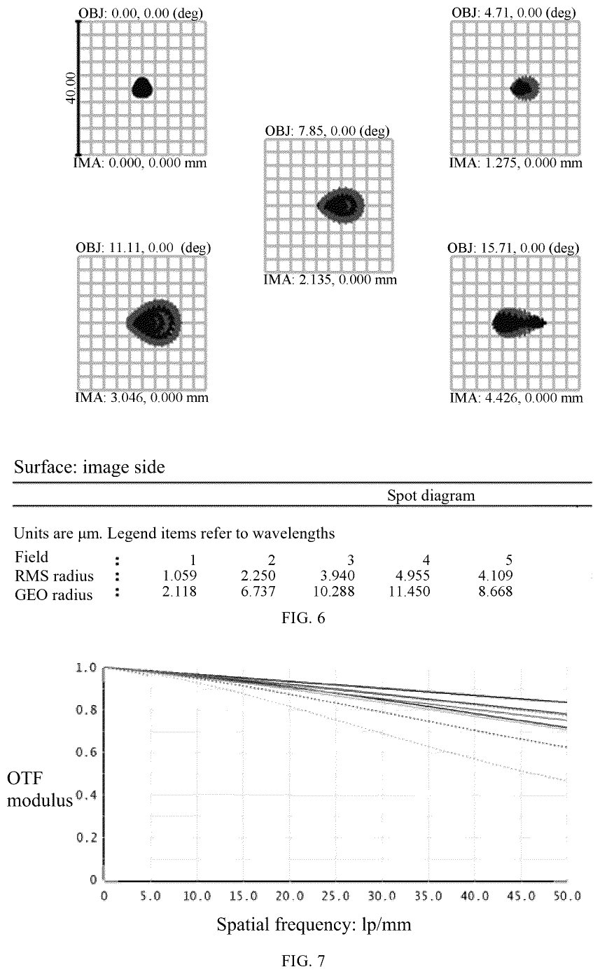

FIG. 5 is a MTF (Modulation Transfer Function) curve diagram of the eyepiece system 10 shown in Table 1 according to the first embodiment of this disclosure. FIG. 6 is a spot diagram of the eyepiece system 10 shown in Table 1 provided by the first embodiment of this disclosure. In FIG. 5, the horizontal axis is the spatial frequency, representing the line logarithm per millimeter, with a unit of lp/mm, and the vertical axis represents the percentage of the imaging quality reaching the physical condition, from 0 to 1.

It may be seen from FIG. 5 and FIG. 6 that the MTF of the eyepiece system 10 is greater than 0.45@50 lp/mm, that is, when the spatial frequency is 50 lp/mm, the imaging quality reaches the least 45% of the physical condition, and the RMS (Root Mean Square) radius of the central field of view of the eyepiece system 10 is less than 5 μm. Therefore, it is shown that the size of the dispersion spot of the eyepiece system 10 is small, the imaging quality is excellent, and the distortion is not perceptible to human eyes, so as to achieve a high-quality imaging effect.

Embodiment 2: this disclosure shows various parameters of seven lenses included in the eyepiece system 10 in combination with Table 2 below.

TABLE 2
f = 15 mm TL = 20.469 mm FOV = 36°

| Lens | | R/ | T/ | L/ | Φ/ | | |
|---|---|---|---|---|---|---|---|
| Name | Surface | mm | mm | mm | m⁻¹ | k | n, V |
| First | Image-Side | 14.538 | 2.823 | 0.268 | 35.25 | 0 | 1.73, 54.7 |
| Lens L1 | Surface | | | | | | |
| | Object Side | 44.801 | | | | 0 | |
| | Surface | | | | | | |
| Second | Image-Side | 12.129 | 1.977 | 0.233 | 20.22 | 0 | 1.82, 46.6 |
| Lens L2 | Surface | | | | | | |
| | Object Side | 16.032 | | | | 0 | |
| | Surface | | | | | | |
| Third | Image-Side | 9.251 | 3.343 | 0.00 | −48.89 | 0 | 1.68, 55.6 |
| Lens L3 | Surface | | | | | | |
| | Object Side | 46.812 | | | | 0 | |
| | Surface | | | | | | |
| Fourth | Image-Side | 46.812 | 1.488 | 1.576 | | 0 | 1.85, 23.8 |
| Lens L4 | Surface | | | | | | |
| | Object Side | 5.365 | | | | 0 | |
| | Surface | | | | | | |
| Fifth | Image-Side | 13.475 | 2.059 | 1.509 | 73.76 | 0 | 1.83, 42.7 |
| Lens L5 | Surface | | | | | | |
| | Object Side | −63.501 | | | | 0 | |
| | Surface | | | | | | |
| Sixth | Image-Side | −9.99 | 1.284 | 0.109 | −53.48 | 0 | 1.76, 26.6 |
| Lens L6 | Surface | | | | | | |
| | Object Side | −35.5 | | | | 0 | |
| | Surface | | | | | | |
| Seventh | Image-Side | 10.252 | 2.3 | 1.5 | 29.49 | 0 | 1.74, 27.8 |
| Lens L7 | Surface | | | | | | |
| | Object Side | 15.68 | | | | 0 | |
| | Surface | | | | | | |

In Table 2, f is a focal length, TL is a total system length, k is a cone coefficient, FOV is an angle of field of view, R is a radius of curvature, T is a center thickness, L is a center distance between itself and the object-side and the adjacent lens or micro display screen, Φ is an optical focal power (the third lens and the fourth lens are glued), n is a refractive index, and V is an Abbe number. In addition, the positive and negative of the radius of curvature of the image-side surface and the object-side surface refers to the relative position between the center of the curved surface and the corresponding surface. For example, a center of an image-side surface of the first lens L1 is located on an object-side of the image-side surface, and a center of an object-side surface of the fifth lens is located on an image-side of the object-side surface.

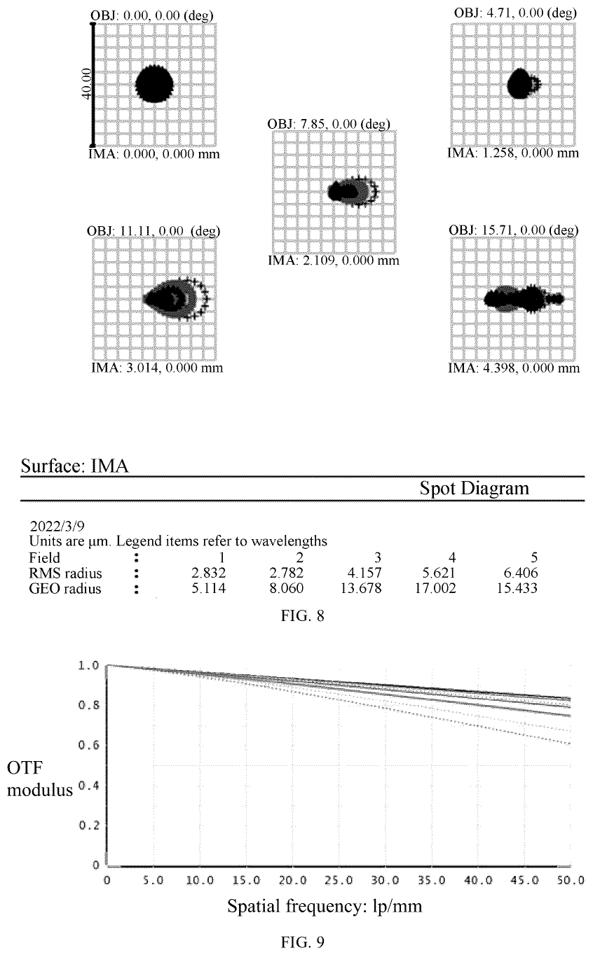

FIG. 7 is a MTF (Modulation Transfer Function) curve diagram of the eyepiece system 10 shown in Table 2 according to the first embodiment of this disclosure. FIG. 8 is a spot diagram of the eyepiece system 10 shown in Table 2 provided by the first embodiment of this disclosure. In FIG. 7, the horizontal axis is the spatial frequency, representing the line logarithm per millimeter, with a unit of lp/mm, and the vertical axis represents the percentage of the imaging quality reaching the physical condition, from 0 to 1.

It may be seen from FIG. 7 and FIG. 8 that the MTF of the eyepiece system 10 is greater than 0.45@50 lp/mm, that is, when the spatial frequency is 50 lp/mm, the imaging quality reaches the least 45% of the physical condition, and the RMS radius of the central field of view of the eyepiece system 10 is less than 6.5 μm. Therefore, it is shown that the size of the dispersion spot of the eyepiece system 10 is small, the imaging quality is excellent, and the distortion is not perceptible to human eyes, so as to achieve a high-quality imaging effect.

Embodiment 3: this disclosure shows various parameters of seven lenses included in the eyepiece system 10 in combination with Table 3 and Table 4 below.

TABLE 3
f = 15 mm TL = 20.569 mm FOV = 36°

| Lens | | R/ | T/ | L/ | Φ/ | | n, |
|---|---|---|---|---|---|---|---|
| Name | Surface | mm | mm | mm | m⁻¹ | k | V |
| First | Image-Side | 12.481 | 3.319 | 0.35 | 41.38 | 0 | 1.73, |
| Lens L1 | Surface | | | | | | 54.7 |
| | Object Side | 38.257 | | | | 0 | |
| | Surface | | | | | | |
| Second | Image-Side | 9.834 | 2.02 | 0.245 | 24.11 | −0.688 | 1.82, |
| Lens L2 | Surface | | | | | | 46.6 |
| | (Aspherical) | | | | | | |
| | Object Side | 12.581 | | | | 0 | |
| | Surface | | | | | | |
| Third | Image-Side | 10.442 | 2.472 | 0.00 | −65.29 | 0 | 1.73, |
| Lens L3 | Surface | | | | | | 51.5 |
| | Object Side | 23.714 | | | | 0 | |
| | Surface | | | | | | |
| Fourth | Image-Side | 23.714 | 1.417 | 1.896 | | 0 | 1.92, |
| Lens L4 | Surface | | | | | | 20.9 |
| | Object Side | 5.448 | | | | 0 | |
| | Surface | | | | | | |
| Fifth | Image-Side | 20.552 | 2.15 | 1.194 | 78.23 | 0 | 1.80, |
| Lens L5 | Surface | | | | | | 42.3 |
| | Object Side | −19.3 | | | | 0 | |
| | Surface | | | | | | |
| Sixth | Image-Side | −7.746 | 1.75 | 0.219 | −40.53 | 0 | 1.72, |
| Lens L6 | Surface | | | | | | 29.5 |
| | Object Side | −14.7 | | | | 0 | |
| | Surface | | | | | | |
| Seventh | Image-Side | 11.503 | 1.973 | 1.564 | 24.84 | 2.366 | 1.76, |
| Lens L7 | Surface | | | | | | 26.6 |
| | (Aspherical) | | | | | | |
| | Object Side | 17.04 | | | | 0 | |
| | Surface | | | | | | |

TABLE 4

| | | Aspherical | Aspherical |
|---|---|---|---|
| Lens Name | Surface | Coefficient A₄ | Coefficient A₆ |
| Second | Image-Side | 5.27E−005 | 4.67E−007 |
| Lens L2 | Surface | | |
| | (Aspherical) | | |
| Seventh | Image-Side | −2.59E−004 | 6.36E−006 |
| Lens L7 | Surface | | |
| | (Aspherical) | | |

In Table 3 and Table 4 above, f is a focal length, TL is a total system length, k is a cone coefficient, FOV is an angle of field of view, R is a radius of curvature, T is a center thickness, L is a distance between itself and the object-side and the center of the adjacent lens or micro display screen, Φ is a focal power (the third lens and the fourth lens are glued), n is a refractive index, V is an Abbe number, A₄ and A₆ are 2*i-order coefficients of the aspheric surface, and i is an integer greater than or equal to 1. In addition, the positive and negative of the radius of curvature of the image-side surface and the object-side surface refers to the relative position between the center of the curved surface and the corresponding surface. For example, a center of an image-side surface of the first lens L1 is located on an object-side of the image-side surface, and a center of an object-side surface of the fifth lens is located on an image-side of the object-side surface.

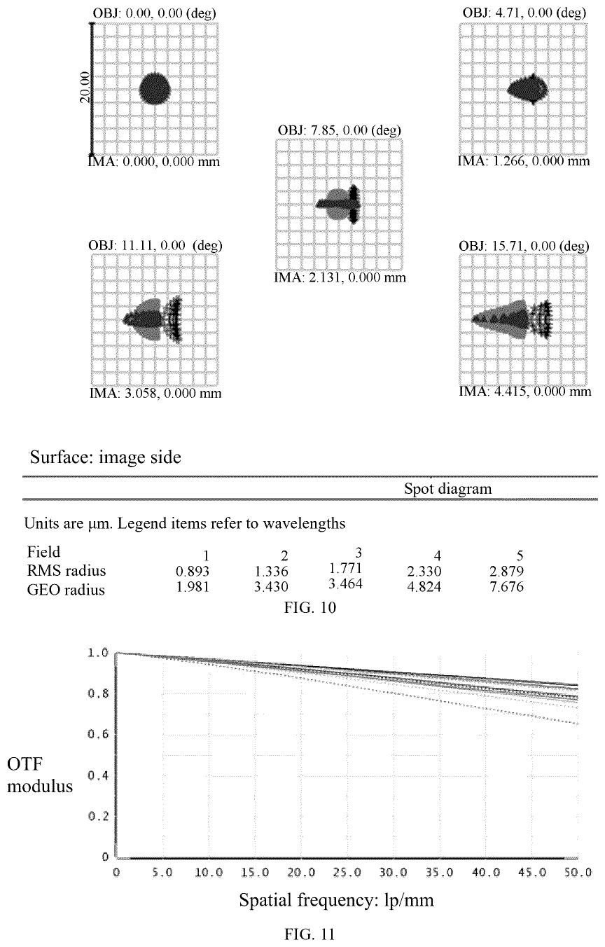

FIG. 9 is a MTF (Modulation Transfer Function) curve diagram of the eyepiece system 10 shown in Table 3 and Table 4 according to the first embodiment of this disclosure. FIG. 10 is a spot diagram of the eyepiece system 10 shown in Table 3 and Table 4 provided by the first embodiment of this disclosure. In FIG. 9, the horizontal axis is the spatial frequency, representing the line logarithm per millimeter, with a unit of lp/mm, and the vertical axis represents the percentage of the imaging quality reaching the physical condition, from 0 to 1.

It may be seen from FIG. 9 and FIG. 10 that the MTF of the eyepiece system 10 is greater than or equal to 0.6@50 lp/mm, that is, when the spatial frequency is 50 lp/mm, the imaging quality reaches the least 60% of the physical condition, and the RMS (Root Mean Square) radius of the central field of view of the eyepiece system 10 is less than 3 μm. Therefore, it is shown that the size of the dispersion spot of the eyepiece system 10 is small, the imaging quality is excellent, and the distortion is not perceptible to human eyes, so as to achieve a high-quality imaging effect.

Embodiment 4: this disclosure shows various parameters of seven lenses included in the eyepiece system 10 in combination with Table 5 and Table 6 below:

TABLE 5
f = 16 mm TL = 19.8639 mm FOV = 36°

| Lens | | R/ | T/ | L/ | Φ/ | | n, |
|---|---|---|---|---|---|---|---|
| Name | Surface | mm | mm | mm | m⁻¹ | k | V |
| First | Image-Side | 16.603 | 3 | 0.3 | 43.92 | 0 | 1.73, |
| Lens L1 | Surface | | | | | | 54.7 |
| | Object Side | Infinite | | | | 0 | |
| | Surface | | | | | | |
| Second | Image-Side | 8.168 | 1.97 | 0.277 | 14.46 | −0.069 | 1.82, |
| Lens L2 | Surface | | | | | | 46.6 |
| | (Aspherical) | | | | | | |
| | Object Side | 8.512 | | | | 0 | |
| | Surface | | | | | | |
| Third | Image-Side | 9.065 | 2.819 | 0.00 | −55.69 | 0 | 1.73, |
| Lens L3 | Surface | | | | | | 51.5 |
| | Object Side | 24.724 | | | | 0 | |
| | Surface | | | | | | |
| Fourth | Image-Side | 24.724 | 1.453 | 2.045 | | 0 | 1.92, |
| Lens L4 | Surface | | | | | | 20.9 |
| | Object Side | 5.166 | | | | 0 | |
| | Surface | | | | | | |
| Fifth | Image-Side | 100.6 | 1.844 | 0.205 | 56.4 | 0 | 1.80, |
| Lens L5 | Surface | | | | | | 42.3 |
| | Object Side | −16.3 | | | | 0 | |
| | Surface | | | | | | |
| Sixth | Image-Side | −39.8 | 2.31 | 0.23 | 3.63 | −4.45 | 1.72, |
| Lens L6 | Surface | | | | | | 29.5 |
| | (Aspherical) | | | | | | |
| | Object Side | −33.9 | | | | 0 | |
| | Surface | | | | | | |
| Seventh | Image-Side | 87.69 | 1.967 | 1.403 | −8.09 | 109 | 1.76, |
| Lens L7 | Surface | | | | | | 26.6 |
| | (Aspherical) | | | | | | |
| | Object Side | 44.96 | | | | 0 | |
| | Surface | | | | | | |

TABLE 6

| | | Aspherical | Aspherical |
|---|---|---|---|
| Lens Name | Surface | Coefficient A₄ | Coefficient A₆ |
| Second | Image-Side | −8.09E−006 | 1.29E−008 |
| Lens L2 | Surface | | |
| | (Aspherical) | | |
| Sixth | Image-Side | −1.23E−003 | −5.47E−006 |
| Lens L6 | Surface | | |
| | (Aspherical) | | |
| Seventh | Image-Side | 9.56E−004 | 4.55E−007 |
| Lens L7 | Surface | | |
| | (Aspherical) | | |

In Table 5 and Table 6 above, f is a focal length, TL is a total system length, k is a cone coefficient, FOV is an angle of field of view, R is a radius of curvature, T is a center thickness, L is a distance between itself and the center of the object-side and the adjacent lens or micro display screen, Φ is an optical focal power (the third lens and the fourth lens are glued), n is a refractive index, V is an Abbe number, A₄ and A₆ are 2*i-order coefficients of the aspheric surface, and i is an integer greater than or equal to 1. In addition, the positive and negative of the radius of curvature of the image-side surface and the object-side surface refers to the relative position between the center of the curved surface and the corresponding surface. For example, a center of an image-side surface of the first lens L1 is located on an object-side of the image-side surface, and a center of an object-side surface of the fifth lens is located on an image-side of the object-side surface.

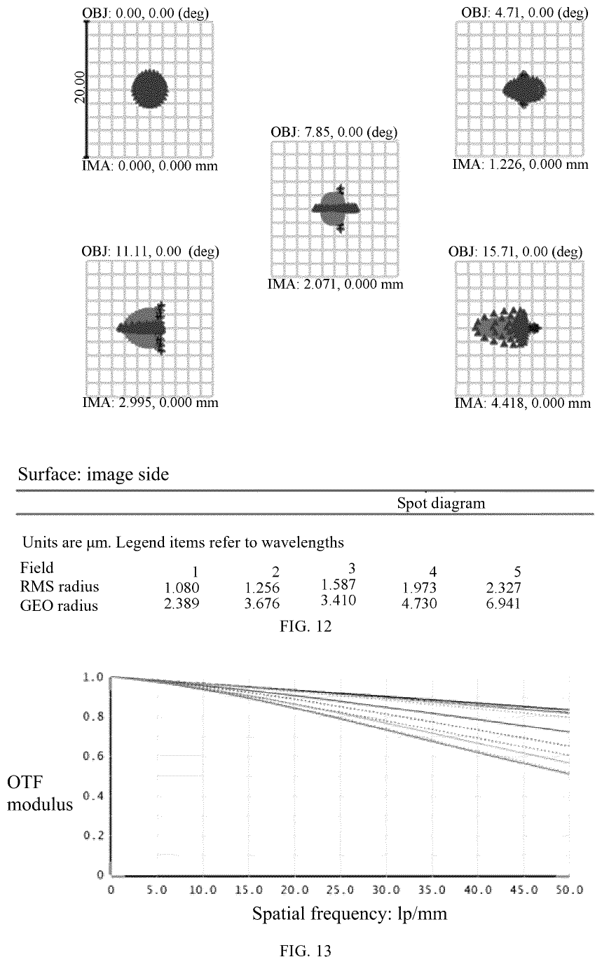

FIG. 11 is a MTF (Modulation Transfer Function) curve diagram of the eyepiece system 10 shown in Table 5 and Table 6 according to the first embodiment of this disclosure. FIG. 12 is a spot diagram of the eyepiece system 10 shown in Table 5 and Table 6 according to the first embodiment of this disclosure. In FIG. 11, the horizontal axis is the spatial frequency, representing the line logarithm per millimeter, with a unit of lp/mm, and the vertical axis represents the percentage of the imaging quality reaching the physical condition, from 0 to 1.

It may be seen from FIG. 11 and FIG. 12 that the MTF of the eyepiece system 10 is greater than or equal to 0.65@50 lp/mm, that is, when the spatial frequency is 50 lp/mm, the imaging quality reaches the least 65% of the physical condition, and the RMS (Root Mean Square) radius of the central field of view of the eyepiece system 10 is less than 2.5 μm. Therefore, it is shown that the size of the dispersion spot of the eyepiece system 10 is small, the imaging quality is excellent, and the distortion is not perceptible to human eyes. so as to achieve a high-quality imaging effect.

Embodiment 5: this disclosure shows various parameters of seven lenses included in the eyepiece system 10 in combination with Table 7 and Table 8 below.

TABLE 7
f = 15 mm TL = 20.03 mm FOV = 36°

| Lens | | R/ | T/ | L/ | Φ/ | | n, |
|---|---|---|---|---|---|---|---|
| Name | Surface | mm | mm | mm | m⁻¹ | k | V |
| First | Image-Side | 11.521 | 3.3 | 0.31 | 45.09 | 0 | 1.73, |
| Lens L1 | Surface | | | | | | 54.7 |
| | Object Side | 31.702 | | | | 0 | |
| | Surface | | | | | | |
| Second | Image-Side | 8.649 | 1.538 | 0.468 | 19.18 | −0.544 | 1.82, |
| Lens L2 | Surface | | | | | | 46.6 |
| | (Aspherical) | | | | | | |
| | Object Side | 8.682 | | | | 0 | |
| | Surface | | | | | | |
| Third | Image-Side | 10.156 | 2.603 | 0.00 | −59.65 | 0 | 1.73, |
| Lens L3 | Surface | | | | | | 51.5 |
| | Object Side | 30.252 | | | | 0 | |
| | Surface | | | | | | |
| Fourth | Image-Side | 30.252 | 1.387 | 2.217 | | 0 | 1.92, |
| Lens L4 | Surface | | | | | | 20.9 |
| | Object Side | 6.046 | | | | 0 | |
| | Surface | | | | | | |
| Fifth | Image-Side | 10.386 | 2.312 | 1.573 | 59.81 | 0 | 1.80, |
| Lens L5 | Surface | | | | | | 42.3 |
| | Object Side | Infinite | | | | 0 | |
| | Surface | | | | | | |
| Sixth | Image-Side | −7.78 | 0.571 | 0.035 | −28.73 | 0 | 1.72, |
| Lens L6 | Surface | | | | | | 29.5 |
| | Object Side | −13.848 | | | | 0 | |
| | Surface | | | | | | |
| Seventh | Image-Side | Infinite | 1.925 | 1.791 | 25.73 | −1.68 | 1.76, |
| Lens L7 | Surface | | | | | | 26.6 |
| | (planar) | | | | | | |
| | Object Side | −19.628 | | | | 0 | |
| | Surface | | | | | | |

TABLE 8

| | | Aspherical | Aspherical |
|---|---|---|---|
| Lens Name | Surface | Coefficient A₄ | Coefficient A₆ |
| Second | Image-Side | 4.8E−005 | 8.17E−007 |
| Lens L2 | (Aspherical) | | |

In Table 7 and Table 8 above, f is a focal length, TL is a total system length, k is a cone coefficient, FOV is an angle of field of view; R is a radius of curvature, T is a center thickness, L is a distance between itself and the center of the object-side and the adjacent lens or micro display screen, Φ is an optical focal power (the third lens and the fourth lens are glued), n is a refractive index, V is an Abbe number, A₄ and A₆ are 2*i-order coefficients of the aspheric surface, and i is an integer greater than or equal to 1. In addition, the positive and negative of the radius of curvature of the image-side surface and the object-side surface refers to the relative position between the center of the curved surface and the corresponding surface. For example, a center of an image-side surface of the first lens L1 is located on an object-side of the image-side surface, and a center of an image-side surface of the sixth lens is located on an image-side of the object-side surface.

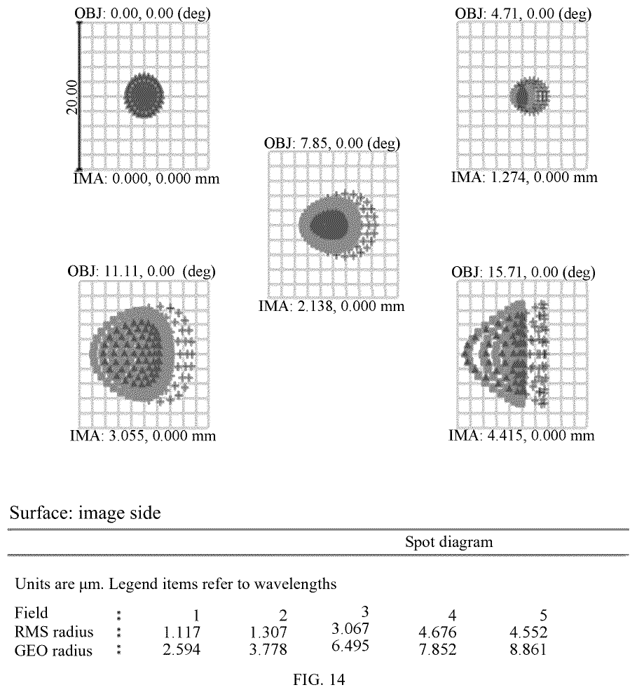

FIG. 13 is a MTF (Modulation Transfer Function) curve diagram of the eyepiece system 10 shown in Table 7 and Table 8 according to the first embodiment of this disclosure. FIG. 14 is a spot diagram of the eyepiece system 10 shown in Table 7 and Table 8 according to the first embodiment of this disclosure. In FIG. 13, the horizontal axis is the spatial frequency, representing the line logarithm per millimeter, with a unit of lp/mm, and the vertical axis represents the percentage of the imaging quality reaching the physical condition, from 0 to 1.

It may be seen from FIG. 13 and FIG. 14 that the MTF of the eyepiece system 10 is greater than or equal to 0.5Φ50 lp/mm, that is, when the spatial frequency is 50 lp/mm, the imaging quality reaches the least 50% of the physical condition, and the RMS (Root Mean Square) radius of the central field of view of the eyepiece system 10 is less than 5 μm. Therefore, it is shown that the size of the dispersion spot of the eyepiece system 10 is small, the imaging quality is excellent, and the distortion is not perceptible to human eyes, so as to achieve a high-quality imaging effect.

An embodiment of this disclosure further provides a near-eye display device, including: an image source, configured to output image light; and the eyepiece system 10 according to the above embodiment, disposed in a light-emitting direction of the image source.

The near-eye display device may be AR glasses, a VR helmet, or the like. The image source may be the micro display screen described above, or may be associated with other displays having a display function.

With reference to the eyepiece system 10 described in the above embodiments, by reducing the total system length TL of the eyepiece system 10, the miniaturization of the near-eye display device is realized while the miniaturization of the eyepiece system 10 is realized. In addition, in combination with the high refractive index, the center thickness, the radius of curvature of the image-side surface and the object-side surface of each lens included in the eyepiece system 10, it is ensured that the eyepiece system 10 has better imaging quality, thereby ensuring that the near-eye display device achieves high-quality imaging.

Other embodiments of this disclosure will be apparent to those skilled in the art from consideration of the specification and practice of the invention disclosed here. This application is intended to cover any variations, uses, or adaptations of this disclosure following the general principles thereof and including common knowledge or conventional technical means in the art that is not disclosed herein. The specification and embodiments are considered to be merely exemplary, and the true scope and spirit of this disclosure is indicated by the appended claims.

1. An eyepiece system, applied to a near-eye display device, the eyepiece system comprising:
a plurality of lenses sequentially disposed along an optical axis from an image-side to an object-side, wherein a refractive index of each of the plurality of lenses is greater than 1.65, and a total system length of the plurality of lenses along the optical axis is less than or equal to 25 mm.

2. The eyepiece system according to claim 1, wherein the optical axis is a main optical axis extending along a linear direction.

3. The eyepiece system according to claim 1, wherein a focal power of the eyepiece system is greater than or equal to 50 m⁻¹ and less than or equal to 65 m⁻¹.

4. The eyepiece system according to claim 1, wherein the plurality of lenses sequentially disposed along the optical axis from the image-side to the object-side comprise:
a first lens having a convex image-side surface and a concave or planar object-side surface;
a second lens having a convex image-side surface and a concave object-side surface;
a third lens having a convex image-side surface and a concave object-side surface;
a fourth lens having a convex image-side surface and a concave object-side surface;
a fifth lens having a convex image-side surface and a convex object-side surface, or having a convex image-side surface and a planar object-side surface;
a sixth lens having a concave image-side surface and a convex object-side surface; and
a seventh lens having a convex image-side surface and a concave object-side surface, or having a planar image-side surface and a convex object-side surface.

5. The eyepiece system according to claim 4, wherein the first lens, the second lens, the third lens, the fifth lens, and the seventh lens are positive focal power lenses, and the fourth lens and the sixth lens are negative focal power lenses.

6. The eyepiece system according to claim 4, wherein the image-side surface and the object-side surface of each of the plurality of lenses are spherical surfaces.

7. The eyepiece system according to claim 4, wherein:
a center thickness of the first lens is greater than or equal to 2.6 mm and less than or equal to 3.4 mm;
a center thickness of the second lens is greater than or equal to 1.4 mm and less than or equal to 2.1 mm;
a center thickness of the third lens is greater than or equal to 2.4 mm and less than or equal to 3.5 mm;
a center thickness of the fourth lens is greater than or equal to 1.3 mm and less than or equal to 1.6 mm;
a center thickness of the fifth lens is greater than or equal to 1.7 mm and less than or equal to 2.4 mm;
a center thickness of the sixth lens is greater than or equal to 0.5 mm and less than or equal to 2.4 mm;
a center thickness of the seventh lens is greater than or equal to 1.8 mm and less than or equal to 3.8 mm.

8. The eyepiece system according to claim 4, wherein:
a radius of curvature of the image-side surface of the first lens is greater than or equal to 10 mm and less than or equal to 20 mm, and a radius of curvature of the object-side surface of the first lens is greater than or equal to 30 mm;
a radius of curvature of the image-side surface of the second lens is greater than or equal to 5 mm and less than or equal to 20 mm, and a radius of curvature of the object-side surface of the second lens is greater than or equal to 5 mm and less than or equal to 25 mm;
a radius of curvature of the image-side surface of the third lens is greater than or equal to 5 mm and less than or equal to 15 mm, and a radius of curvature of the object-side surface of the third lens is greater than or equal to 15 mm and less than or equal to 55 mm;
a radius of curvature of the image-side surface of the fourth lens is greater than or equal to 15 mm and less than or equal to 55 mm, and a radius of curvature of the object-side surface of the fourth lens is less than or equal to 10 mm;
a radius of curvature of the image-side surface of the fifth lens is greater than or equal to 5 mm and less than or equal to 110 mm, and a radius of curvature of the object-side surface of the fifth lens is greater than or equal to 10 mm;
a radius of curvature of the image-side surface of the sixth lens is less than or equal to 50 mm, and a radius of curvature of the object-side surface of the sixth lens is greater than or equal to 10 mm and less than or equal to 40 mm;
a radius of curvature of the image-side surface of the seventh lens is greater than or equal to 5 mm, and a radius of curvature of the object-side surface of the seventh lens is greater than or equal to 10 mm and less than or equal to 50 mm.

9. The eyepiece system according to claim 8, wherein the object-side surface of the third lens and the image-side surface of the fourth lens are spherical surfaces, and have a same radius of curvature;
the object-side surface of the third lens and the image-side surface of the fourth lens are glued by an optical adhesive.

10. The eyepiece system according to claim 4, wherein:
a refractive index of the first lens is greater than or equal to 1.72 and less than or equal to 1.74;
a refractive index of the second lens is greater than or equal to 1.78 and less than or equal to 1.84;
a refractive index of the third lens is greater than or equal to 1.65 and less than or equal to 1.80;
a refractive index of the fourth lens is greater than or equal to 1.80 and less than or equal to 1.95;
a refractive index of the fifth lens is greater than or equal to 1.75 and less than or equal to 1.85;
a refractive index of the sixth lens and a refractive index of the seventh lens are each greater than or equal to 1.70 and less than or equal to 1.80.

11. The eyepiece system according to claim 4, wherein:
each of the first lens and the third lens has an Abbe number of greater than or equal to 45 and less than or equal to 60;
each of the second lens and the fifth lens has an Abbe number of greater than or equal to 40 and less than or equal to 50;
each of the fourth lens, the sixth lens, and the seventh has an Abbe number of greater than or equal to 20 and less than or equal to 30.

12. The eyepiece system according to claim 1, wherein a material of each lens is glass or resin.

13. (canceled)

14. The eyepiece system according to claim 4, wherein the image-side surface and the object-side surface of the first lens, the object-side surface of the second lens, the image-side surface and the object-side surface of the third lens, the image-side surface and the object-side surface of the fourth lens, the image-side surface and the object-side surface of the fifth lens, the image-side surface and the object-side surface of the sixth lens, and the object-side surface of the seventh lens are spherical surfaces; and the image-side surface of the second lens and the image-side surface of the seventh lens are aspheric surfaces.

15. The eyepiece system according to claim 4, wherein the image-side surface and the object-side surface of the first lens, the object-side surface of the second lens, the image-side surface and the object-side surface of the third lens, the image-side surface and the object-side surface of the fourth lens, the image-side surface and the object-side surface of the fifth lens, the object-side surface of the sixth lens, and the object-side surface of the seventh lens are spherical surfaces; and the image-side surface of the second lens, the image-side surface of the sixth lens, and the image-side surface of the seventh lens are aspheric surfaces.

16. A near-eye display device, comprising:
an image source configured to output image light; and
an eyepiece system disposed in a light-emitting direction of the image source,
wherein the eyepiece system comprises a plurality of lenses sequentially disposed along an optical axis from an image-side to an object-side, wherein a refractive index of each of the plurality of lenses is greater than 1.65, and a total system length of the plurality of lenses along the optical axis is less than or equal to 25 mm.

17. The near-eye display device according to claim 16, wherein the optical axis is a main optical axis extending along a linear direction.

18. The near-eye display device according to claim 16, wherein a focal power of the eyepiece system is greater than or equal to 50 m⁻¹ and less than or equal to 65 m⁻¹.

19. The near-eye display device according to claim 16, wherein the plurality of lenses sequentially disposed along the optical axis from the image-side to the object-side comprise:
a first lens having a convex image-side surface and a concave or planar object-side surface;
a second lens having a convex image-side surface and a concave object-side surface;
a third lens having a convex image-side surface and a concave object-side surface;
a fourth lens having a convex image-side surface and a concave object-side surface;
a fifth lens having a convex image-side surface and a convex object-side surface, or having a convex image-side surface and a planar object-side surface;
a sixth lens having a concave image-side surface and a convex object-side surface; and
a seventh lens having a convex image-side surface and a concave object-side surface, or having a planar image-side surface and a convex object-side surface.

20. The near-eye display device according to claim 19, wherein the first lens, the second lens, the third lens, the fifth lens, and the seventh lens are positive focal power lenses, and the fourth lens and the sixth lens are negative focal power lenses.

21. The near-eye display device according to claim 19, wherein the image-side surface and the object-side surface of each of the plurality of lenses are spherical surfaces.
